(19) United States
(12) Patent Application Publication
(10) Pub. No.: US 2014/0021928 A1
(43) Pub. Date: Jan. 23, 2014

(54) DC-DC CONTROLLER AND DC-DC CONVERTER

(71) Applicant: Wei-Ling Chen, Hsinchu County (TW)

(72) Inventor: Wei-Ling Chen, Hsinchu County (TW)

(73) Assignee: UPI SEMICONDUCTOR CORP., Hsinchu County (TW)

(21) Appl. No.: 13/615,692

(22) Filed: Sep. 14, 2012

(30) Foreign Application Priority Data
Jul. 20, 2012 (TW) 101126324

(51) Int. Cl. G05F 1/10

(52) U.S. Cl. 323/271

(57) ABSTRACT

A DC-DC controller and a DC-DC converter are provided. The DC-DC converter includes the DC-DC controller and an output stage circuit. The DC-DC controller includes an error amplifier, a comparator, a constant on time calculation circuit, and a ramp generator. The error amplifier receives a first reference voltage and a feedback signal to generate an error signal. The comparator compares a ramp signal and the error signal to generate a trigger signal. The constant on time calculation circuit receives the trigger signal and generates a pulse width modulated signal to the output stage circuit according to the trigger signal, and provides a minimum on time signal. The ramp generator receives the minimum on time signal and generates the ramp signal, wherein an amplitude of the ramp signal has no proportional relationship with an input voltage or an output voltage of the output stage circuit.

### CROSS-REFERENCE TO RELATED APPLICATION

This application claims the priority benefit of Taiwan application serial no. 101126324, filed on Jul. 20, 2012. The entirety of the above-mentioned patent application is hereby incorporated by reference herein and made a part of this specification.

### BACKGROUND OF THE INVENTION

1. Field of the Invention

The invention relates to a power source control technology, and in particular, to a DC-DC controller and a DC-DC converter based on a constant on time (COT) architecture.

2. Description of Related Art

FIG. 1 is a circuit block diagram of a conventional DC-DC converter. The conventional DC-DC converter 100 includes a DC-DC controller 110 and an output stage circuit 120. The DC-DC controller 110 includes an error amplifier 112, a comparator 114, a pulse width modulated circuit 116, and a ramp generator 118. The error amplifier 112 generates an error signal Yen according to a reference voltage Vref and a feedback signal Vfb. The comparator 114 compares a ramp signal Sramp and the error signal Verr to generate a trigger signal Str. The pulse width modulated circuit 116 generates a pulse width modulated signal Spwm according to the driving of the trigger signal Str. The ramp generator 118 generates the ramp signal Sramp according to the pulse width modulated signal Spwm, an input voltage Vin, and an output voltage Vout.

In the current technology, the ramp signal Sramp has a proportional relationship with the input voltage Vin and/or the output voltage Vout, as shown in FIG. 2. Please refer to FIG. 2. FIG. 2 is a diagram illustrating a relationship between the input voltage Vin at different potentials and the ramp signal Sramp, the error signal Verr, and the pulse width modulated signal Spwm. When the input voltage Vin is at higher potential, the ramp signal Sramp has a waveform 210; and when the input voltage Vin is at lower potential, the ramp signal Sramp has a waveform 220. An included angle between the ramp signal Sramp and the error signal Verr varies according to the potentials of the input voltage Vin. The included angles are θ1 and θ2 respectively when the input voltage Vin is at higher and lower potentials.

Generally speaking, noise interference may be prevented if the included angle between the ramp signal Sramp and the error signal Ven is sufficiently large, and accordingly a signal to noise ratio (SNR) of the DC-DC converter is raised. When the input voltage Vin is at lower potential, the included angle θ2 becomes smaller, that is, θ2<θ1. Although the included angle is conducive to reducing noise, the signal to noise ratio is worse when the input voltage Vin is at lower potential. Therefore, an improved DC-DC controller and an improved DC-DC converter are required.

### SUMMARY OF THE INVENTION

Based on the above, the invention provides a DC-DC controller and a DC-DC converter for solving the aforementioned problems of the conventional technology.

The invention provides a DC-DC controller coupled to an output stage circuit. The DC-DC controller includes an error amplifier, a comparator, a constant on time calculation circuit, and a ramp generator. The error amplifier receives a first reference voltage and a feedback signal to generate an error signal, wherein the feedback signal is associated with an output voltage of the output stage circuit. The comparator is coupled to the error amplifier and compares a ramp signal and the error signal to generate a trigger signal. The constant on time calculation circuit is coupled to the comparator. The constant on time calculation circuit receives the trigger signal and generates a pulse width modulated signal to the output stage circuit according to the trigger signal, and provides a minimum on time signal. The ramp generator is coupled to the comparator and the constant on time calculation circuit. The ramp generator receives the minimum on time signal to generate the ramp signal, wherein an amplitude of the ramp signal has no proportional relationship with an input voltage or the output voltage of the output stage circuit.

According to an embodiment of the invention, the ramp generator includes an amplifier, a first switch, a second switch, a current source, and a capacitor. The amplifier includes an input terminal for receiving a second reference voltage and another input terminal for receiving a first signal from an output terminal thereof. The first switch includes a first terminal, a second terminal, and a first control terminal, wherein the first terminal is coupled to the output terminal of the amplifier, and the first control terminal receives the minimum on time signal. The second switch includes a third terminal, a fourth terminal, and a second control terminal, wherein the third terminal is coupled to the second terminal, the second control terminal receives a control signal, and the control signal is a reverse signal of the minimum on time signal. The current source is coupled between the fourth terminal and a ground terminal. The capacitor is coupled between the second terminal and the ground terminal. Herein, the ramp signal is provided from where the first switch, the second switch, and the capacitor are coupled.

According to an embodiment of the invention, a waveform of the ramp signal before turning from a rising edge to a falling edge is cut off and remains cut off for a predetermined time, and the cut off waveform is associated with the second reference voltage.

According to an embodiment of the invention, a length of the predetermined time is associated with the minimum on time signal.

According to an embodiment of the invention, the amplitude of the ramp signal is associated with the second reference voltage.

According to an embodiment of the invention, a falling slope of the ramp signal is associated with operation frequencies of the first switch and the second switch.

According to an embodiment of the invention, the DC-DC controller further includes a compensation circuit. The compensation circuit is coupled between the output terminal of the error amplifier and the ground terminal for compensating for the error signal.

According to an embodiment of the invention, when the components of the DC-DC controller are disposed in an integrated circuit, the integrated circuit does not include connection terminals for the input voltage and the output voltage.

From another aspect, the invention provides a DC-DC converter that includes an error amplifier, a comparator, a constant on time calculation circuit, a ramp generator, and an output stage circuit. The error amplifier receives a first reference voltage and a feedback signal to generate an error signal. The comparator is coupled to the error amplifier and compares a ramp signal and the error signal to generate a trigger signal. The constant on time calculation circuit is coupled to the comparator. The constant on time calculation circuit receives the trigger signal to generate a pulse width modulated signal and provides a minimum on time signal. The ramp generator is coupled to the comparator and the constant on time calculation circuit, and receives the minimum on time signal to generate the ramp signal. The output stage circuit is coupled to the constant on time calculation circuit, and receives the pulse width modulated signal and converts an input voltage to an output voltage. Herein, the feedback signal is associated with the output voltage, but an amplitude of the ramp signal has no proportional relationship with the input voltage or the output voltage of the output stage circuit.

Based on the above, the ramp signal of the invention does not change in proportion to the input voltage and the output voltage, and thus the included angle of the error signal and the ramp signal does not vary according to the input voltage and the output voltage. Accordingly, higher signal to noise ratio is maintained in any input voltage or output voltage.

To make the above features and advantages of the invention more comprehensible, several embodiments accompanied with drawings are described in detail as follows.

### BRIEF DESCRIPTION OF THE DRAWINGS

The accompanying drawings are included to provide further understanding, and are incorporated in and constitute a part of this specification. The drawings illustrate embodiments and, together with the description, serve to explain the principles of the invention.

FIG. 1 is a circuit block diagram of a conventional DC-DC converter.

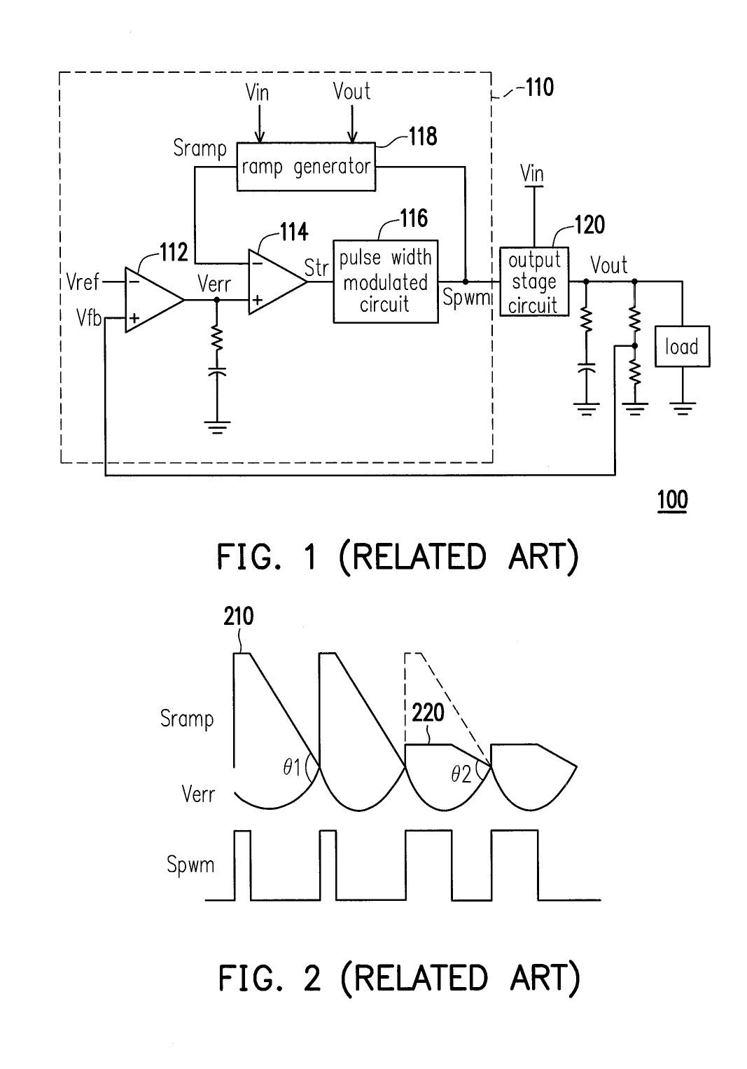

FIG. 2 is a diagram illustrating a relationship between an input voltage at different potentials and a ramp signal, an error signal, and a pulse width modulated signal.

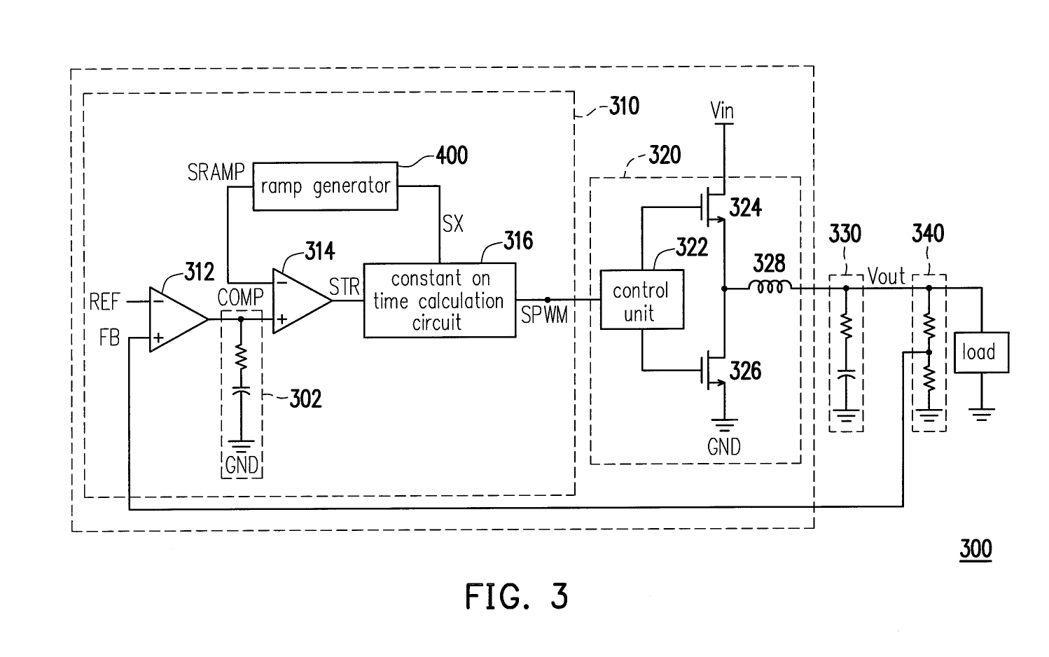

FIG. 3 is a circuit block diagram of a DC-DC converter according to an embodiment of the invention.

FIG. 4 is a circuit diagram of a ramp generator according to FIG. 3.

FIGS. 5A through 5D illustrate waveforms of a pulse width modulated signal and relevant signals of the ramp generator of FIG. 4.

### DESCRIPTION OF THE EMBODIMENTS

Reference will now be made in detail to the exemplary embodiments of the invention, examples of which are illustrated in the accompanying drawings. In addition, whenever possible, identical or similar reference numbers stand for identical or similar elements in the figures and the embodiments.

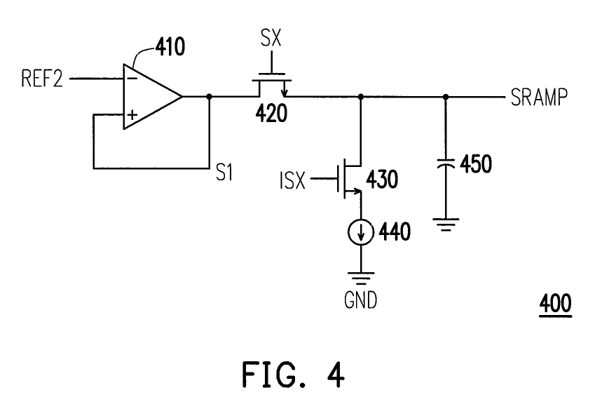

FIG. 3 is a circuit block diagram of a DC-DC converter according to an embodiment of the invention. Please refer to FIG. 3. A DC-DC converter 300 includes a DC-DC controller 310 and an output stage circuit 320. The DC-DC controller 310 includes an error amplifier 312, a comparator 314, a constant on time calculation circuit 316, and a ramp generator 400. The comparator 314 is coupled to the error amplifier 312. The constant on time calculation circuit 316 is coupled to the comparator 314. The ramp generator 400 is coupled to the comparator 314 and the constant on time calculation circuit 316.

The error amplifier 312 receives a first reference voltage REF and a feedback signal FB to generate an error signal COMP, wherein the feedback signal FB is associated with and has a fixed proportional relationship with an output voltage Vout of the output stage circuit 320. The comparator 314 compares a ramp signal SRAMP and the error signal COMP and generates a trigger signal STR to drive the constant on time calculation circuit 316. The constant on time calculation circuit 316 receives the trigger signal STR and generates a pulse width modulated signal SPWM to the output stage circuit 320 according to the trigger signal STR. The constant on time calculation circuit 316 provides a minimum on time signal SX to the ramp generator 400. The minimum on time signal SX is also used to generate the pulse width modulated signal SPWM, so as to ensure that a switch operation is not less than a minimum on time when the pulse width modulated signal SPWM is enabled. The ramp generator 400 receives the minimum on time signal SX and generates the ramp signal SRAMP accordingly.

It is noted that a way of generating the ramp signal SRAMP is not associated with the input voltage Vin or the output voltage Vout of the output stage circuit 320, but associated with the minimum on time signal SX.

In addition, the DC-DC controller 310 may further include a compensation circuit 302. The compensation circuit 302 is coupled between an output terminal and a ground terminal GND of the error amplifier 312 for compensating for the error signal COMP. The output stage circuit 320 includes a control unit 322, two switches 324 and 326, and an inductor 328. The control unit 322 receives the pulse width modulated signal SPWM to drive the switches 324 and 326. The output stage circuit 320 is used to convert the input voltage Vin to the output voltage Vout.

In this embodiment, the DC-DC converter 300 further includes a compensation circuit 330 and a feedback circuit 340. The compensation circuit 330 is coupled between the output terminal and the ground terminal GND of the output stage circuit 320 for compensating for the output voltage Vout. The feedback circuit 340 is a circuit composed of a plurality of resistors, which provides the feedback signal FB by a voltage division rule, and the feedback signal FB may be in proportion to the output voltage Vout.

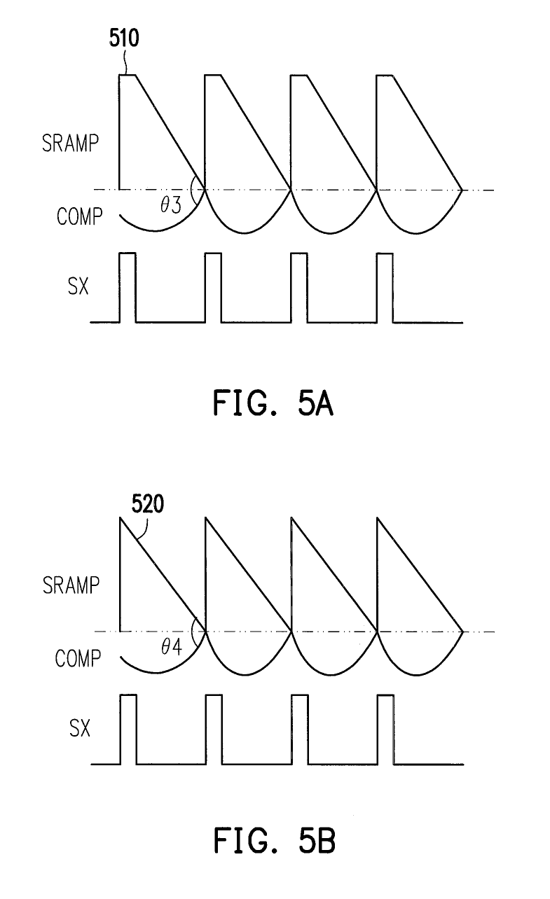

FIG. 4 is a circuit diagram of a ramp generator according to FIG. 3. Please refer to FIG. 4. The ramp generator 400 includes an amplifier 410, a first switch 420, a second switch 430, a current source 440, and a capacitor 450. The amplifier 410 includes a non-reverse input terminal for receiving a second reference voltage REF2 and a reverse input terminal for receiving a first signal S1 from an output terminal thereof.

It is noted that the second reference voltage REF2 can be any voltage value, and has no proportional relationship with the input voltage Vin or the output voltage Vout of FIG. 3. In another exemplary embodiment, the second reference voltage REF2 is 1V, but the invention is not limited thereto. On the other hand, the current source 440 is a fixed current value, and has no proportional relationship with the input voltage Vin or the output voltage Vout of FIG. 3.

In this embodiment, the first switch 420 and the second switch 430 are implemented by transistors, but the invention is not limited thereto. A first terminal of the first switch 420 is coupled to an output terminal of the amplifier 410. A first terminal of the second switch 430 is coupled to a second terminal of the first switch 420. A control terminal of the first switch 420 receives the minimum on time signal SX, and a control terminal of the second switch 430 receives a control signal ISX, wherein the control signal ISX is a reverse signal of the minimum on time signal SX. An on state of the first switch 420 is controlled by the minimum on time signal SX, and an on state of the second switch 430 is controlled by the control signal ISX. Therefore, an adjustment to the minimum on time signal SX is equivalent to an adjustment to an operation frequency of the first switch 420 and the second switch 430. The current source 440 is coupled between the second terminal of the second switch 430 and the ground terminal GND. The capacitor 450 is coupled between the second terminal of the first switch 420 and the ground terminal GND. Herein, the ramp signal SRAMP is provided from where the first switch 420, the second switch 430, and the capacitor 450 are coupled.

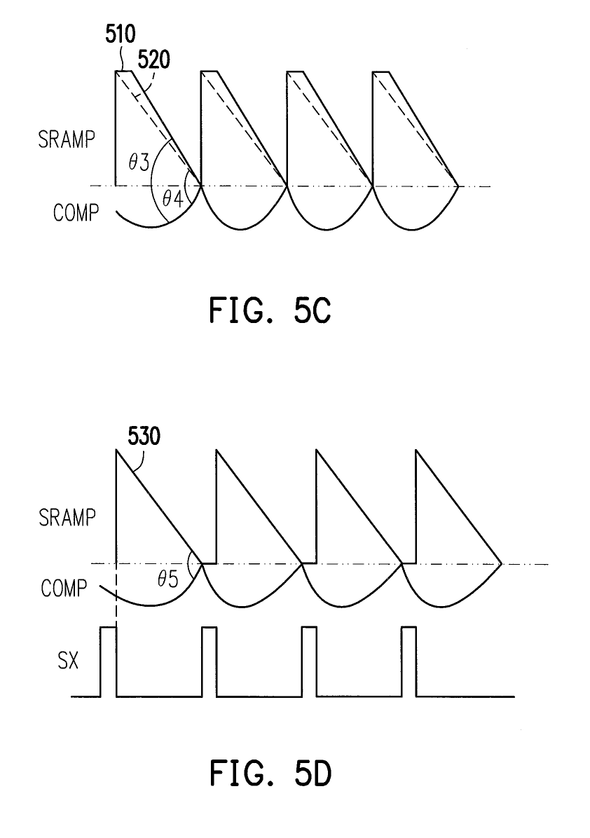

FIGS. 5A through 5D illustrate waveforms of the pulse width modulated signal and relevant signals of the ramp generator 440 of FIG. 4.

Please refer to FIGS. 5A, 5B, and 5C. Please refer to FIG. 4 together with FIGS. 5A, 5B, and 5C. In the first embodiment, a way of generating the ramp signal SRAMP is related to a rising edge of the minimum on time signal SX. In FIG. 5A, a waveform of the ramp signal SRAMP is clamped by the second reference voltage REF2 and a portion of the waveform is cut off. A waveform 510 of the ramp signal SRAMP and the error signal COMP form an included angle θ3. In FIG. 5B, the second reference voltage REF2 does not clamp the ramp signal SRAMP, and thus the waveform 520 of the ramp signal SRAMP is a complete ramp wave. The ramp signal SRAMP and the error signal COMP form an included angle θ4. It is known from the embodiments of FIG. 5A and FIG. 5B that the amplitude design of the ramp signal SRAMP is associated with the second reference voltage REF2, and the amplitude of the ramp signal SRAMP is maintained at a fixed value. Because the way the ramp signal SRAMP is generated is not changed in proportion to the input voltage Vin and/or the output voltage Vout (see FIG. 3), and the included angle θ3 or θ4 of the error signal COMP and the ramp signal SRAMP does not vary according to the input voltage Vin or the output voltage Vout, higher signal to noise ratio (SNR) is maintained in any input voltage Vin or output voltage Vout.

Furthermore, according to the waveform of FIG. 5C, it is known that θ3>θ4. That is, the waveform 510 before turning from the rising edge to the falling edge is cut off and maintained for a predetermined time. Compared with the included angle θ4 of the waveform 520, the included angle θ3 of the waveform 510 is conducive to reducing more noise.

FIG. 5D illustrates the second embodiment. The way of generating the ramp signal SRAMP is related to a falling edge of the minimum on time signal SX. A waveform 530 of the ramp signal SRAMP and the error signal COMP form an included angle θ5. The method that triggers and generates the ramp signal SRAMP by the falling edge of the minimum on time signal SX is similar to the rule that triggers by the rising edge. Therefore, detailed descriptions will not be repeated hereinafter.

Please refer to FIG. 4 and FIG. 5A. A portion of the waveform of the ramp signal SRAMP is cut off by the second reference voltage REF2 and the cut off waveform is maintained for a predetermined time. A length of the predetermined time is associated with a pulse width of the minimum on time signal SX because the pulse width of the minimum on time signal SX affects the operations of the first switch 420 and the second switch 430. For example, when the first switch 420 changes from on to off and the second switch 430 changes from off to on, the capacitor 450 begins discharging and simultaneously the waveform of the ramp signal SRAMP turns from cut-off to the falling edge.

It is noted that the components of the DC-DC controller in the above embodiments may be disposed in an integrated circuit (IC). The integrated circuit may not include connection terminals (or pins) for the input voltage and the output voltage, so as to spare two terminals. Since the invention uses the minimum on time signal to generate the ramp signal, and the minimum on time signal has no proportional relationship with the input voltage and the output voltage, the invention is able to achieve the noise reduction effect as the conventional circuit and furthermore greatly reduces the area of the integrated circuit. Moreover, the formation of the ramp wave, which has no proportional relationship with the input voltage and the output voltage, is achieved without any additional terminal, and thus the spared terminals of the integrated circuit may be defined to provide other functions. In addition, the amplitude of the ramp signal is associated with the adjustment of the second reference voltage, and the falling slope of the ramp signal may be adjusted according to the minimum on time signal to form a more suitable included angle, thereby increasing the signal to noise ratio.

To conclude the above, the DC-DC controller and the DC-DC converter of the invention use the ramp signal that does not change in proportion to the input voltage and/or the output voltage, and thus the included angle of the error signal and the ramp signal does not vary according to the input voltage or the output voltage. Accordingly, higher signal to noise ratio is maintained in any input voltage or output voltage.

Although the invention has been described with reference to the above embodiments, it will be apparent to one of the ordinary skill in the art that modifications to the described embodiments may be made without departing from the spirit of the invention. Accordingly, the scope of the invention is defined by the attached claims not by the above detailed descriptions.

What is claimed is:

1. A DC-DC controller coupled to an output stage circuit, the DC-DC controller comprising:
an error amplifier receiving a first reference voltage and a feedback signal to generate an error signal, wherein the feedback signal is associated with an output voltage of the output stage circuit;
a comparator coupled to the error amplifier and comparing a ramp signal and the error signal to generate a trigger signal;
a constant on time calculation circuit coupled to the comparator, receiving the trigger signal and generating a pulse width modulated signal to the output stage circuit according to the trigger signal, and providing a minimum on time signal; and
a ramp generator coupled to the comparator and the constant on time calculation circuit and receiving the minimum on time signal to generate the ramp signal, wherein an amplitude of the ramp signal has no proportional relationship with an input voltage or the output voltage of the output stage circuit.

2. The DC-DC controller according to claim 1, wherein the ramp generator comprises:
an amplifier comprising an input terminal for receiving a second reference voltage and another input terminal for receiving a first signal from an output terminal thereof;
a first switch comprising a first terminal, a second terminal, and a first control terminal, wherein the first terminal is coupled to the output terminal of the amplifier, and the first control terminal receives the minimum on time signal;
a second switch comprising a third terminal, a fourth terminal, and a second control terminal, wherein the third terminal is coupled to the second terminal, the second control terminal receives a control signal, and the control signal is a reverse signal of the minimum on time signal;
a current source coupled between the fourth terminal and a ground terminal; and
a capacitor coupled between the second terminal and the ground terminal,
wherein the ramp signal is provided from where the first switch, the second switch, and the capacitor are coupled.

3. The DC-DC controller according to claim 2, wherein a waveform of the ramp signal before turning from a rising edge to a falling edge is cut off and remains cut off for a predetermined time, and the cut off waveform is associated with the second reference voltage.

4. The DC-DC controller according to claim 3, wherein a length of the predetermined time is associated with the minimum on time signal.

5. The DC-DC controller according to claim 2, wherein the amplitude of the ramp signal is associated with the second reference voltage.

6. The DC-DC controller according to claim 2, wherein a falling slope of the ramp signal is associated with an operation frequency of the first switch and the second switch.

7. The DC-DC controller according to claim 1, further comprising:
a compensation circuit coupled between an output terminal of the error amplifier and a ground terminal for compensating for the error signal.

8. The DC-DC controller according to claim 1, wherein, when components of the DC-DC controller are disposed in an integrated circuit, the integrated circuit does not comprise connection terminals for the input voltage and the output voltage.

9. A DC-DC converter, comprising:
an error amplifier receiving a first reference voltage and a feedback signal to generate an error signal;
a comparator coupled to the error amplifier and comparing a ramp signal and the error signal to generate a trigger signal;
a constant on time calculation circuit coupled to the comparator, receiving the trigger signal to generate a pulse width modulated signal, and providing a minimum on time signal;
a ramp generator coupled to the comparator and the constant on time calculation circuit and receiving the minimum on time signal to generate the ramp signal; and
an output stage circuit coupled to the constant on time calculation circuit, receiving the pulse width modulated signal, and converting an input voltage to an output voltage;
wherein the feedback signal is associated with the output voltage, but an amplitude of the ramp signal has no proportional relationship with the input voltage or the output voltage of the output stage circuit.

10. The DC-DC converter according to claim 9, wherein the ramp generator comprises:
an amplifier comprising an input terminal for receiving a second reference voltage and another input terminal for receiving a first signal from an output terminal thereof;
a first switch comprising a first terminal, a second terminal, and a first control terminal, wherein the first terminal is coupled to the output terminal of the amplifier, and the first control terminal receives the minimum on time signal;
a second switch comprising a third terminal, a fourth terminal, and a second control terminal, wherein the third terminal is coupled to the second terminal, the second control terminal receives a control signal, and the control signal is a reverse signal of the minimum on time signal;
a current source coupled between the fourth terminal and a ground terminal; and
a capacitor coupled between the second terminal and the ground terminal,
wherein the ramp signal is provided from where the first switch, the second switch, and the capacitor are coupled.

11. The DC-DC converter according to claim 10, wherein a waveform of the ramp signal before turning from a rising edge to a falling edge is cut off and remains cut off for a predetermined time, and the cut off waveform is associated with the second reference voltage.

12. The DC-DC converter according to claim 11, wherein a length of the predetermined time is associated with the minimum on time signal.

13. The DC-DC converter according to claim 10, wherein the amplitude of the ramp signal is associated with the second reference voltage.

14. The DC-DC converter according to claim 10, wherein a falling slope of the ramp signal is associated with an operation frequency of the first switch and the second switch.

15. The DC-DC converter according to claim 9, further comprising:
a compensation circuit coupled between an output terminal of the error amplifier and a ground terminal for compensating for the error signal.
